(19) United States
(12) Patent Application Publication
(10) Pub. No.: US 2020/0133156 A1
(43) Pub. Date: Apr. 30, 2020

(54) EXPOSURE APPARATUS AND IMAGE FORMING APPARATUS

(71) Applicant: Konica Minolta, Inc., Tokyo (JP)

(72) Inventors: Takahiro Matsuo, Toyokawa-shi (JP); Hajime Taniguchi, Toyokawa-shi (JP); Atsushi Nagaoka, Okazaki-shi (JP); Ryo Hasegawa, Tokyo (JP)

(21) Appl. No.: 16/598,749

(22) Filed: Oct. 10, 2019

(30) Foreign Application Priority Data
Oct. 29, 2018 (JP) 2018-203247

(51) Int. Cl. G03G 15/043; G03G 21/16

(52) U.S. Cl. CPC G03G 15/0435; G03G 2215/0412; G03G 2221/1636; G03G 21/1647

(57) ABSTRACT

An exposure apparatus includes: light source substrates on which light sources aligned in a first direction are aligned in rows and formed on a formation surface; an optical element that causes light emitted from the light sources to form an image on a surface of an image carrier that has a cylindrical shape and rotates with a rotational symmetry axis parallel to the first direction; a microlens array in which the optical elements aligned in the first direction are aligned in rows; and a holder that holds the light source substrates, wherein in each of the light source substrates, at least two of the light sources are formed at different positions in a second direction intersecting with the first direction and being parallel to the formation surface, and the holder holds the light source substrates to cause the formation surfaces of the light source substrates to cross each other.

The entire disclosure of Japanese patent Application No. 2018-203247, filed on Oct. 29, 2018, is incorporated herein by reference in its entirety.

### BACKGROUND

### Technological Field

The present invention relates to an exposure apparatus and an image forming apparatus, and particularly to an exposure apparatus in which a plurality of light sources are arranged along a main scanning direction, and an image forming apparatus provided with the exposure apparatus.

### Description of the Related Art

In recent years, a print head using an organic light-emitting diode (OLED) as a light source is known. This print head forms an electrostatic latent image on a photoreceptor drum by irradiating the photoreceptor drum as an image carrier with light emitted from a plurality of light sources. Further, there is known a line head in which a plurality of light sources are arranged at different positions in a sub scanning direction in order to improve resolution. In this line head, since a shape of a surface of the photoreceptor drum has a curvature, distances from the plurality of light sources arranged at different positions in the sub scanning direction to the photoreceptor drum are different.

For example, JP 2008-221790 A describes an image forming apparatus in which, when a plane area where a light emitting element group is arranged is defined as an arrangement plane of the light emitting element group, and a distance in an optical axis direction between the arrangement plane of the light emitting element group and a vertex of a light emitting element group-side lens surface of the lens is defined as a distance between opposed lenses, the distance between the opposed lenses of each light emitting element group is adjusted so that an imaging position of a light beam emitted from the light emitting element group is a position corresponding to the curvature shape of the surface of the latent image carrier.

However, the technology described in JP 2008-221790 A has a problem that it is necessary to adjust the distance between the opposed lenses of each of a plurality of light sources formed on a substrate, which complicates production of the substrate. In addition, in order to increase the resolution in the main scanning direction, it is conceivable to arrange a plurality of substrates along the sub scanning direction. In this case, it is necessary to adjust the distance between the opposed lenses of each of the plurality of light sources individually formed on the plurality of substrates, which causes a problem that positioning is difficult.

### SUMMARY

In order to solve the above-mentioned problems, one of objects of the present invention is to provide an exposure apparatus capable of converging light emitted from a plurality of light sources onto a surface of a cylindrical image carrier.

Another object of the present invention is to provide an image forming apparatus capable of converging light emitted from a plurality of light sources onto a surface of a cylindrical image carrier.

To achieve at least one of the abovementioned objects, according to an aspect of the present invention, an exposure apparatus reflecting one aspect of the present invention comprises: a plurality of light source substrates on which a plurality of light sources aligned in a first direction are aligned in a plurality of rows and formed on a formation surface; an optical element that causes light emitted from the light sources to form an image on a surface of an image carrier that has a cylindrical shape and rotates with a rotational symmetry axis parallel to the first direction; a microlens array in which a plurality of the optical elements aligned in the first direction are aligned in a plurality of rows; and a holder that holds a plurality of the light source substrates, wherein in each of a plurality of the light source substrates, at least two of the light sources are formed at different positions in a second direction intersecting with the first direction and being parallel to the formation surface, and the holder holds a plurality of the light source substrates to cause the formation surfaces of a plurality of the light source substrates to cross each other.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view showing an appearance of an MFP according to an embodiment of the present invention;

FIG. 2 is a block diagram showing an outline of a hardware configuration of the MFP in the present embodiment;

FIG. 3 is a schematic cross-sectional view showing an internal configuration of the MFP;

FIG. 4 is a perspective view showing an example of an internal configuration of an exposure apparatus;

FIG. 5 is a perspective view of a first light source substrate;

FIG. 6 is a plan view of a state where three of the first light source substrate, a second light source substrate, and a third light source substrate are combined;

FIG. 7 is a plan view of a microlens array;

FIG. 8 is a side view showing an internal configuration of the microlens array;

FIG. 9 is an end view showing an internal configuration of the exposure apparatus;

FIG. 10 is a first view schematically showing a relationship between positions of a plurality of light sources and irradiation positions on a photoreceptor drum;

FIG. 11 is a second view schematically showing a relationship between positions of the plurality of light sources and irradiation positions on the photoreceptor drum;

FIG. 12 is an end view showing an internal configuration of an exposure apparatus according to a modification;

FIG. 13 is a first view schematically showing a relationship between positions of a plurality of light sources and irradiation positions on a photoreceptor drum according to a modification; and

FIG. 14 is a second view schematically showing a relationship between positions of the plurality of light sources and irradiation positions on the photoreceptor drum according to the modification.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same reference numerals are given to the same parts. Their names and functions are also the same. Therefore, detailed description thereof will not be repeated.

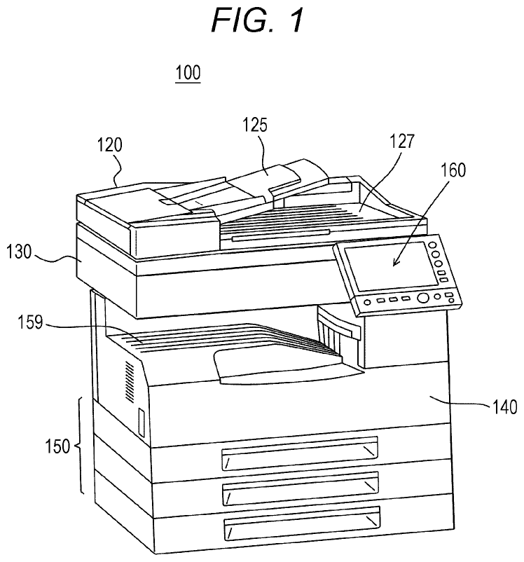

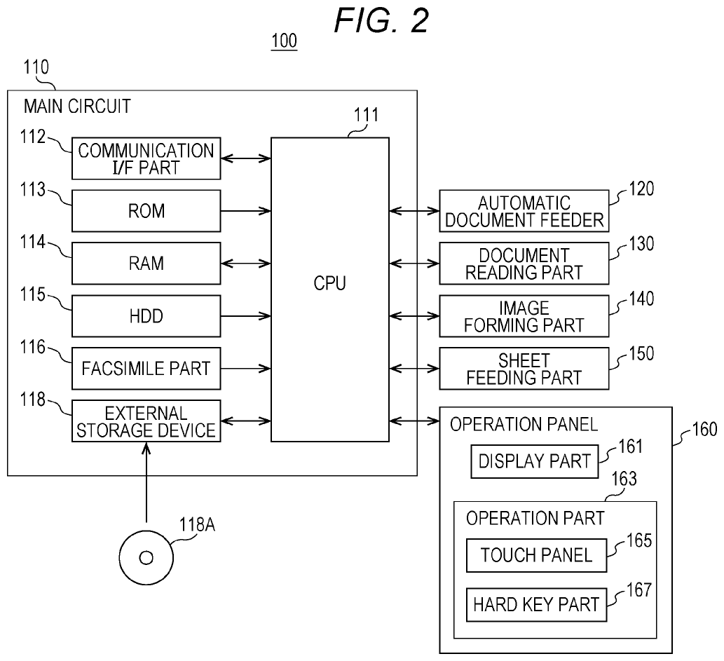

FIG. 1 is a perspective view showing an appearance of an MFP according to an embodiment of the present invention. FIG. 2 is a block diagram showing an outline of a hardware configuration of the MFP in the present embodiment. Referring to FIGS. 1 and 2, a multi function peripheral (MFP) 100 is an example of an image forming apparatus, and includes: a main circuit 110; a document reading part 130 to read a document; an automatic document feeder 120 to convey a document to the document reading part 130; an image forming part 140 to form an image on a sheet on the basis of image data; a sheet feeding part 150 to supply a sheet to the image forming part 140; and an operation panel 160 as a user interface.

The automatic document feeder 120 automatically conveys a plurality of documents that have been set on a document tray 125 one by one to a document reading position of the document reading part 130, and discharges a document whose image formed on the document has been read by the document reading part 130, onto a document discharge tray 127.

The document reading part 130 has a rectangular reading surface to read a document. The reading surface is formed of, for example, a platen glass. The automatic document feeder 120 is connected to a main body of the MFP 100 so as to be rotatable about an axis parallel to one side of the reading surface, and can be opened and closed. The document reading part 130 is disposed below the automatic document feeder 120, and the reading surface of the document reading part 130 is exposed in an open state where the automatic document feeder 120 is rotated and opened. Therefore, the user can place a document on the reading surface of the document reading part 130. The automatic document feeder 120 can change a state between an open state where the reading surface of the document reading part 130 is exposed and a closed state where the reading surface is covered.

The image forming part 140 forms an image on a sheet conveyed by the sheet feeding part 150, through a known electrophotographic system. In the present embodiment, the image forming part 140 forms an image on a sheet conveyed by the sheet feeding part 150 under image forming conditions corresponding to image data and a medium type of the sheet. The sheet formed with the image is discharged to a discharge tray 159.

The main circuit 110 includes a central processing part (CPU) 111 that controls the entire MFP 100, a communication interface (I/F) part 112, a read only memory (ROM) 113, a random access memory (RAM) 114, a hard disk drive (HDD) 115 as a large capacity storage device, a facsimile part 116, and an external storage device 118. The CPU 111 is connected to the automatic document feeder 120, the document reading part 130, the image forming part 140, the sheet feeding part 150, and the operation panel 160, and controls the entire MFP 100.

The ROM 113 stores a program to be executed by the CPU 111 or data necessary for executing the program. The RAM 114 is used as a work area when the CPU 111 executes a program. Further, the RAM 114 temporarily stores image data continuously sent from the document reading part 130.

The operation panel 160 is provided on an upper part of MFP 100. The operation panel 160 includes a display part 161 and an operation part 163. The display part 161 is, for example, a liquid crystal display (LCD), and displays an instruction menu for the user, information regarding acquired image data, and the like. Note that, in place of the LCD, for example, an organic electroluminescence (EL) display can be used as long as it is a device that displays an image.

The operation part 163 includes a touch panel 165 and a hard key part 167. The touch panel 165 is an electrostatic capacity type. Moreover, the touch panel 165 is not limited to the electrostatic capacity type, but may be another type, for example, such as a resistive film type, a surface acoustic wave type, an infrared type, or an electromagnetic induction type.

The touch panel 165 is provided with a detection surface thereof being superimposed on the display part 161, on an upper surface or a lower surface of the display part 161. Here, a size of the detection surface of the touch panel 165 is the same as a size of a display surface of the display part 161. Therefore, a coordinate system of the display surface is the same as a coordinate system of the detection surface. The touch panel 165 detects, through the detection surface, a position instructed by the user on the display surface of the display part 161, and outputs coordinates of the detected position to the CPU 111. Since the coordinate system of the display surface and the coordinate system of the detection surface are the same, the coordinates outputted from the touch panel 165 can be replaced with coordinates of the display surface.

The hard key part 167 includes a plurality of hard keys. The hard key is, for example, a contact switch. The touch panel 165 detects a position instructed by the user on the display surface of the display part 161. Since the user is often in an upright posture when operating the MFP 100, the display surface of the display part 161, an operation surface of the touch panel 165, and the hard key part 167 are arranged facing upward. The user can easily visually recognize the display surface of the display part 161, and the user can easily instruct the operation part 163 with a finger.

The communication I/F part 112 is an interface to connect the MFP 100 to a network. The communication I/F part 112 communicates with another computer or data processing apparatus connected to the network, through a communication protocol such as transmission control protocol (TCP) or a file transfer protocol (FTP). The network connected with the communication I/F part 112 is a local area network (LAN), and a connection form may be wired or wireless. Further, the network is not limited to the LAN, but may be a wide area network (WAN), a public switched telephone network (PSTN), the Internet, or the like.

The facsimile part 116 is connected to a public switched telephone network (PSTN) to transmit facsimile data to the PSTN or receive facsimile data from the PSTN. The facsimile part 116 stores the received facsimile data in the HDD 115, converts the received facsimile data into print data printable by the image forming part 140, and outputs the print data to the image forming part 140. Thus, the image forming part 140 forms an image of facsimile data received by the facsimile part 116, on a sheet. Further, the facsimile part 116 converts the data stored in the HDD 115 into facsimile data to transmit the facsimile data to a facsimile device connected to the PSTN.

The external storage device 118 is controlled by the CPU 111, and mounted with a compact disk read only memory (CD-ROM) 118A or a semiconductor memory. In the present embodiment, an example in which the CPU 111 executes a program stored in the ROM 113 is described. However, the CPU 111 may control the external storage device 118 to read a program to be executed by the CPU 111 from the CD-ROM 118A, and store the read program in the RAM 114 to execute.

The CPU 111 controls the image forming part 140 to form an image of image data on a recording medium such as a sheet. The image data outputted from the CPU 111 to the image forming part 140 includes image data such as print data received from outside, in addition to image data inputted from the document reading part 130.

A medium that stores a program to be executed by the CPU 111 is not limited to the CD-ROM 118A, but may be a flexible disk, a cassette tape, an optical disk (magnetic optical disc (MO)/mini disc (MD)/digital versatile disc (DVD)), an IC card, an optical card, or a semiconductor memory such as a mask ROM, an erasable programmable ROM (EPROM), or an electrically EPROM (EEPROM). Furthermore, the CPU 111 may download a program from a computer connected to the network and store the program in the HDD 115, or the computer connected to the network may write the program into the HDD 115, to cause the program stored in the HDD 115 to be loaded into the RAM 114 and executed by the CPU 111. The program as used herein includes a source program, a compressed program, an encrypted program, and the like, in addition to a program directly executable by the CPU 111.

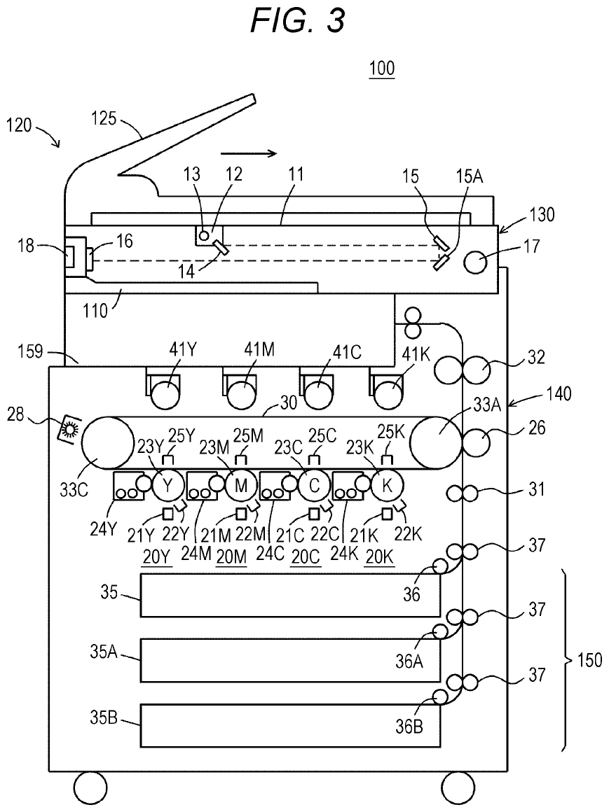

FIG. 3 is a schematic cross-sectional view showing an internal configuration of the MFP. Referring to FIG. 3, the automatic document feeder 120 separates one or more documents placed on the document tray 125, and conveys the documents one by one to the document reading part 130. The document reading part 130 exposes an image of a document that has been set on a document glass 11 by the automatic document feeder 120, with an exposure lamp 13 attached to a slider 12 that moves below. Reflected light from the document is guided to a lens 16 by a mirror 14 and two reflection mirrors 15 and 15A, and forms an image on a charge coupled devices (CCD) sensor 18. The exposure lamp 13 and the mirror 14 are attached to the slider 12, and the slider 12 is moved by a scanner motor 17 in an arrow direction (sub scanning direction) shown in FIG. 3 at a velocity V according to a copy magnification. This allows the document set on the document glass 11 to be scanned over the entire surface. Further, along with the movement of the exposure lamp 13 and the mirror 14, the two reflection mirrors 15 and 15A move in the arrow direction in FIG. 3 at a velocity V/2. As a result, a light path length of light emitted to the document by the exposure lamp 13 from being reflected on the document until forming an image on the CCD sensor 18 becomes always constant.

The reflected light imaged on the CCD sensor 18 is converted into image data as an electric signal in the CCD sensor 18, and sent to the main circuit 110. The main circuit 110 performs A/D conversion processing, digital image processing, and the like on the received analog image data, and then outputs the image data to the image forming part 140. The main circuit 110 converts the image data into printing data of cyan (C), magenta (M), yellow (Y), and black (K), and outputs the printing data to the image forming part 140.

The image forming part 140 includes image forming units 20Y, 20M, 20C, and 20K for yellow, magenta, cyan, and black, respectively. Here, “Y”, “M”, “C”, and “K” represent yellow, magenta, cyan, and black, respectively. By driving at least one of the image forming units 20Y, 20M, 20C, and 20K, an image is formed. When all of the image forming units 20Y, 20M, 20C, and 20K are driven, a full color image is formed. Printing data of yellow, magenta, cyan, and black are respectively inputted to the image forming units 20Y, 20M, 20C, and 20K. Since the image forming units 20Y, 20M, 20C, and 20K merely differ in a color of toner to be handled, the image forming unit 20Y to form a yellow image will be described here.

The image forming unit 20Y includes: an exposure apparatus 21Y to be inputted with yellow printing data; a photoreceptor drum 23Y that is an image carrier of the exposure apparatus 21Y; an electrostatic charger 22Y; a developing device 24Y; a transfer charger 25Y; and a toner bottle 41Y. The toner bottle 41Y stores yellow toner.

The exposure apparatus 21Y emits light in accordance with printing data (electric signal) received from the main circuit 110, and exposes the photoreceptor drum 23Y, which is a subject. The photoreceptor drum 23Y has a cylindrical shape, and rotates around a rotational symmetry axis. Here, the rotational symmetry axis is parallel to the sub scanning direction. After being charged by the electrostatic charger 22Y, the photoreceptor drum 23Y is irradiated with a laser beam emitted by the exposure apparatus 21Y. This causes an electrostatic latent image to be formed on the photoreceptor drum 23Y. Subsequently, by the developing device 24Y placing toner supplied from the toner bottle 41Y on the electrostatic latent image, a toner image is formed. The toner image formed on the photoreceptor drum 23Y is transferred onto an intermediate transfer belt 30 by the transfer charger 25Y.

Whereas, the intermediate transfer belt 30 is suspended so as not to be loosen, by a drive roller 33C and a roller 33A. When the drive roller 33C rotates counterclockwise in FIG. 3, the intermediate transfer belt 30 rotates counterclockwise in the figure at a predetermined velocity. Along with the rotation of the intermediate transfer belt 30, the roller 33A rotates counterclockwise.

This causes the image forming units 20Y, 20M, 20C, and 20K to sequentially transfer toner images onto the intermediate transfer belt 30. Timing at which each of the image forming units 20Y, 20M, 20C, and 20K transfers a toner image onto the intermediate transfer belt 30 is adjusted by detecting a reference mark attached to the intermediate transfer belt 30. As a result, yellow, magenta, cyan, and black toner images are superimposed on the intermediate transfer belt 30.

The toner image formed on the intermediate transfer belt 30 is transferred to a sheet by a transfer roller 26. The sheet having the transferred toner image is conveyed to a fixing roller pair 32 and heated by the fixing roller pair 32. This causes the toner to be melted and fixed on the sheet. Thereafter, the sheet is discharged to the discharge tray 159.

On upstream of the image forming unit 20Y of the intermediate transfer belt 30, a removing device 28 is provided. The removing device 28 removes toner remaining on the intermediate transfer belt 30.

In sheet feeding cassettes 35, 35A, and 35B, sheets having different sizes are individually set. The sheet stored in each of the sheet feeding cassettes 35, 35A, and 35B is supplied to a conveying path by take-out rollers 36, 36A, and 36B respectively attached to the sheet feeding cassettes 35, 35A, and 35B, and sent to a timing roller 31 by a sheet feeding roller 37.

The MFP 100 drives all of the image forming units 20Y, 20M, 20C, and 20K when forming a full-color image, but drives any one of the image forming units 20Y, 20M, 20C, and 20K when forming a monochrome image. In addition, an image can be formed by combining two or more of the image forming units 20Y, 20M, 20C, and 20K. Note that, here, the MFP 100 is described as a tandem system including the image forming units 20Y, 20M, 20C, and 20K that form four color toners on a sheet, but the MFP 100 may be a four-cycle system in which four color toners are sequentially transferred onto a sheet with a single photoreceptor drum.

Next, the exposure apparatuses 21Y, 21M, 21C, and 21K will be described. Since all the configurations of the individual exposure apparatuses 21Y, 21M, 21C, and 21K are the same, the exposure apparatus 21Y will be described as an example here.

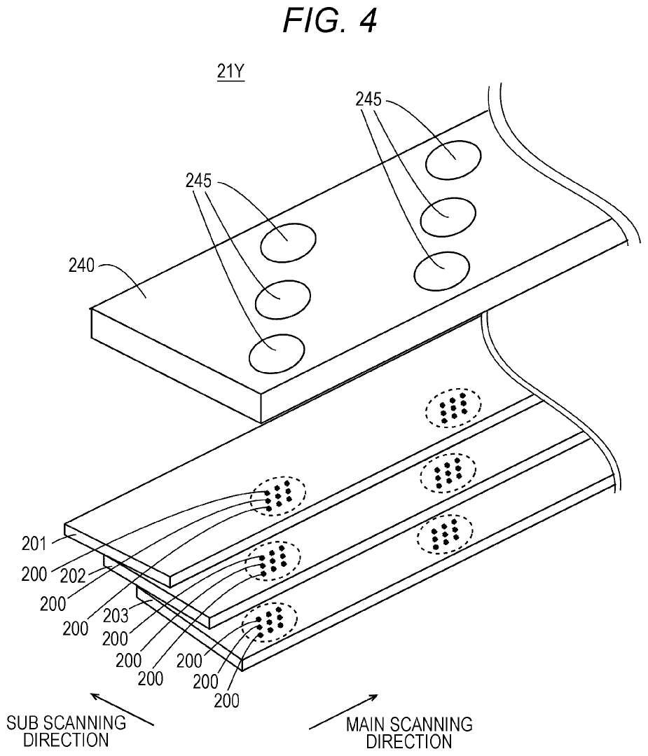

FIG. 4 is a perspective view showing an example of an internal configuration of an exposure apparatus. Referring to FIG. 4, the exposure apparatus 21Y includes: an exposure unit including: three of a first light source substrate 201, a second light source substrate 202, and a third light source substrate 203; and a microlens array 240. The microlens array 240 includes a plurality of optical elements 245. On each of the first light source substrate 201, the second light source substrate 202, and the third light source substrate 203, a plurality of light sources 200 are formed. Since individual configurations of the first light source substrate 201, the second light source substrate 202, and the third light source substrate 203 are the same, the configuration will be described here with the first light source substrate 201 as an example.

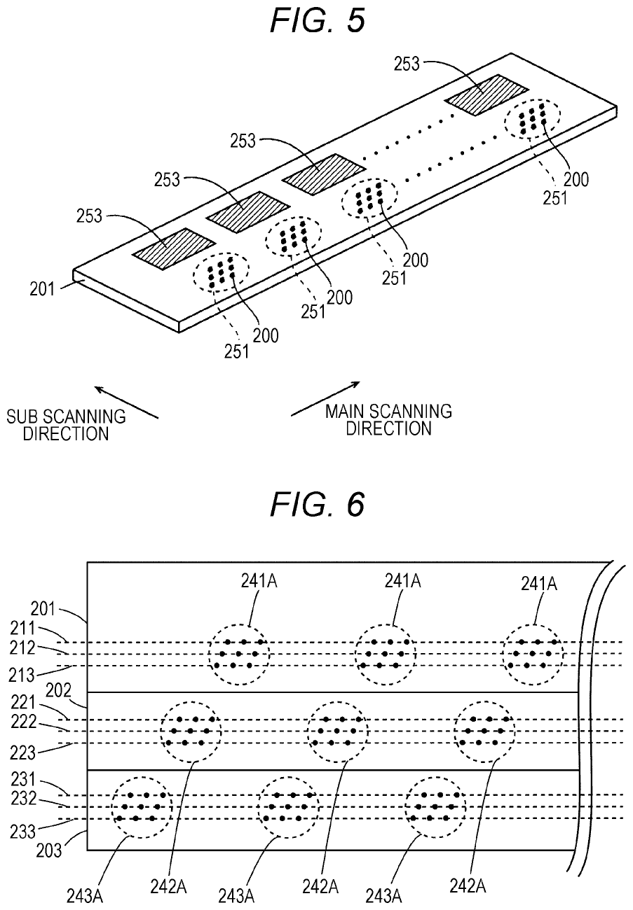

FIG. 5 is a perspective view of the first light source substrate. Referring to FIG. 5, the first light source substrate 201 includes a plurality of light emitting areas 251 formed with the plurality of light sources 200, and a plurality of circuit areas 253 formed with a circuit. The plurality of light emitting areas 251 individually correspond to the plurality of circuit areas 253. In the circuit area 253 corresponding to one light emitting area 251, there is formed a driving circuit to drive each of the plurality of light sources 200 formed in the light emitting area 251.

Referring back to FIG. 4, the first light source substrate 201, the second light source substrate 202, and the third light source substrate 203 are arranged to overlap in the sub scanning direction. The second light source substrate 202 is disposed below the first light source substrate 201, and the third light source substrate 203 is disposed below the second light source substrate 202. A part of the first light source substrate 201 is overlapped with a part of the second light source substrate 202, and a part of the second light source substrate 202 is overlapped with a part of the third light source substrate 203. The circuit area 253 of the second light source substrate 202 is overlapped with a part of the first light source substrate 201, but the light emitting area 251 is not overlapped with the first light source substrate 201. The circuit area 253 of the third light source substrate 203 is overlapped with a part of the second light source substrate 202, but the light emitting area 251 is not overlapped with the second light source substrate 202. Therefore, light emitted from the plurality of light sources 200 each formed on the first light source substrate 201, the second light source substrate 202, and the third light source substrate 203 is emitted toward the optical elements 245, which are provided in the microlens array 240 so as to individually face the first light source substrate 201, the second light source substrate 202, and the third light source substrate 203.

In the first light source substrate 201, a part including the light emitting area 251 thereof may be overlapped at least with a part of the second light source substrate 202. In the second light source substrate 202, a part including the light emitting area 251 thereof may be overlapped with a part of the third light source substrate 203.

FIG. 6 is a plan view of a state where three of the first light source substrate, the second light source substrate, and the third light source substrate are combined. Referring to FIG. 6, the plurality of light sources 200 formed on the first light source substrate 201 belong to one of three light source groups 211, 212, and 213. The plurality of light sources 200 belonging to the light source group 211 are arranged along the main scanning direction, and positions in the sub scanning direction orthogonal to the main scanning direction are the same. The plurality of light sources 200 belonging to the light source group 212 are arranged along the main scanning direction, and positions in the sub scanning direction are the same. The plurality of light sources 200 belonging to the light source group 213 are arranged along the main scanning direction, and positions in the sub scanning direction are the same. The light source groups 211, 212, and 213 in the first light source substrate 201 are arranged along the sub scanning direction. In other words, positions in the sub scanning direction are different in the plurality of light sources 200 belonging to the light source group 211, the plurality of light sources 200 belonging to the light source group 212, and the plurality of light sources 200 belonging to the light source group 213. The light source group 211 is arranged at a position closest to the circuit area 253 in the sub scanning direction, and the light source group 213 is arranged at a position farthest from the circuit area 253 in the sub scanning direction.

The plurality of light sources 200 formed on the second light source substrate 202 belong to one of three light source groups 221, 222, and 223. The plurality of light sources 200 belonging to the light source group 221 are arranged along the main scanning direction, and positions in the sub scanning direction are the same. The plurality of light sources 200 belonging to the light source group 222 are arranged along the main scanning direction, and positions in the sub scanning direction are the same. The plurality of light sources 200 belonging to the light source group 223 are arranged along the main scanning direction, and positions in the sub scanning direction are the same. The light source groups 221, 222, and 223 in the second light source substrate 202 are arranged along the sub scanning direction. In other words, positions in the sub scanning direction are different in the plurality of light sources 200 belonging to the light source group 221, the plurality of light sources 200 belonging to the light source group 222, and the plurality of light sources 200 belonging to the light source group 223. The light source group 221 is arranged at a position closest to the circuit area 253 in the sub scanning direction, and the light source group 223 is arranged at a position farthest from the circuit area 253 in the sub scanning direction.

The plurality of light sources 200 formed on the third light source substrate 203 belong to one of three light source groups 231, 232, and 233. The plurality of light sources 200 belonging to the light source group 231 are arranged along the main scanning direction, and positions in the sub scanning direction are the same. The plurality of light sources 200 belonging to the light source group 232 are arranged along the main scanning direction, and positions in the sub scanning direction are the same. The plurality of light sources 200 belonging to the light source group 233 are arranged along the main scanning direction, and positions in the sub scanning direction are the same. The light source groups 231, 232, and 233 in the third light source substrate 203 are arranged along the sub scanning direction. In other words, positions in the sub scanning direction are different in the plurality of light sources 200 belonging to the light source group 231, the plurality of light sources 200 belonging to the light source group 232, and the plurality of light sources 200 belonging to the light source group 233. The light source group 231 is arranged at a position closest to the circuit area 253 in the sub scanning direction, and the light source group 233 is arranged at a position farthest from the circuit area 253 in the sub scanning direction.

In the present embodiment, the first light source substrate 201, the second light source substrate 202, and the third light source substrate 203 are positioned such that the light source group 211 included in the first light source substrate 201 is arranged on the most downstream in the sub scanning direction, and the light source group 233 included in the third light source substrate 203 is arranged on the most upstream in the sub scanning direction. Here, individual positions of the light source groups 211, 212, and 213 included in the first light source substrate 201, the light source groups 221, 222, and 223 included in the second light source substrate 202, and the light source groups 231, 232, and 233 included in the third light source substrate 203 are indicated by the Nth row (N is a positive integer) with use of the order from upstream in the sub scanning direction. Specifically, the light source group 233 included in the third light source substrate 203 is the first row since being on the most upstream in the sub scanning direction, and the light source group 211 included in the first light source substrate 201 is the ninth row since being on the most downstream. Moreover, the first light source substrate 201, the second light source substrate 202, and the third light source substrate 203 may be positioned such that the light source group 211 included in the first light source substrate 201 is arranged on the most upstream in the sub scanning direction, and the light source group 233 included in the third light source substrate 203 is arranged on the most downstream in the sub scanning direction, by rotating the photoreceptor drum 23Y in the reverse direction.

Further, in the present embodiment, the first light source substrate 201 includes three light source groups 211, 212, and 213, the second light source substrate 202 includes three light source groups 221, 222, and 223, and the third light source substrate 203 includes the light source groups 231, 232, and 233. However, the number of light source groups included in one light source substrate is not limited to this, but may be determined in accordance with the size of the optical element 245, and may simply be one or more.

The plurality of light sources 200 formed on the first light source substrate 201 are classified into any of a plurality of lens groups 241A. The lens group 241A is a collection of the plurality of light sources 200 that emit light passing through one of the optical elements 245 described later. Therefore, the plurality of lens groups 241A individually correspond to the plurality of optical elements 245. A predetermined number of light sources classified into one lens group 241A among the plurality of light sources 200 belonging to the light source group 211 are arranged continuously at equal intervals in the main scanning direction. A predetermined number of light sources classified into one lens group 241A among the plurality of light sources 200 belonging to the light source group 212 are arranged continuously at equal intervals in the main scanning direction. A predetermined number of light sources classified into one lens group 241A among the plurality of light sources 200 belonging to the light source group 213 are arranged continuously at equal intervals in the main scanning direction.

The predetermined number is the same as the number of the light source groups 211, 212, and 213 included in the first light source substrate 201. In the present embodiment, the predetermined number is three. In the first light source substrate 201, three light sources 200 among the plurality of light sources 200 belonging to the light source group 211, three light sources 200 among the plurality of light sources 200 belonging to the light source group 212, and three light sources 200 among the plurality of light sources 200 belonging to the light source group 213 belong to a first lens group 241A. Further, among nine light sources 200 included in the first lens group 241A, the light source 200 belonging to the light source group 212 that is arranged in a center in the sub scanning direction among the light source groups 211, 212, and 213 and being at a center in the main scanning direction is to be a center of the first lens group 241A. Each of the light source groups 211, 212, and 213 includes more than three light sources 200, which is a predetermined number. Therefore, in the first light source substrate 201, a plurality of first lens groups 241A are arranged along the main scanning direction.

Note that the number of the light source groups 211, 212, and 213 included in the first light source substrate 201 is “3” in the present embodiment. However, without being limited to this, the number may be determined in accordance with the size of the optical element 245, and may simply be one or more.

Similarly, in the second light source substrate 202, three light sources 200 among the plurality of light sources 200 belonging to the light source group 221, three light sources 200 among the plurality of light sources 200 belonging to the light source group 222, and three light sources 200 among the plurality of light sources 200 belonging to the light source group 223 belong to a second lens group 242A. Further, among nine light sources 200 included in the second lens group 242A, the light source 200 belonging to the light source group 222 that is arranged in a center in the sub scanning direction among the light source groups 221, 222, and 223 and being at a center in the main scanning direction is to be a center of the second lens group 242A. In the second light source substrate 202, a plurality of second lens groups 242A are arranged along the main scanning direction.

Similarly, in the third light source substrate 203, three light sources 200 among the plurality of light sources 200 belonging to the light source group 231, three light sources 200 among the plurality of light sources 200 belonging to the light source group 232, and three light sources 200 among the plurality of light sources 200 belonging to the light source group 233 belong to a third lens group 243A. Further, among nine light sources 200 included in the third lens group 243A, the light source 200 belonging to the light source group 232 that is arranged in a center in the sub scanning direction among the light source groups 231, 232, and 233 and being at a center in the main scanning direction is to be a center of the third lens group 243A. In the third light source substrate 203, the plurality of third lens groups 243A are arranged along the main scanning direction.

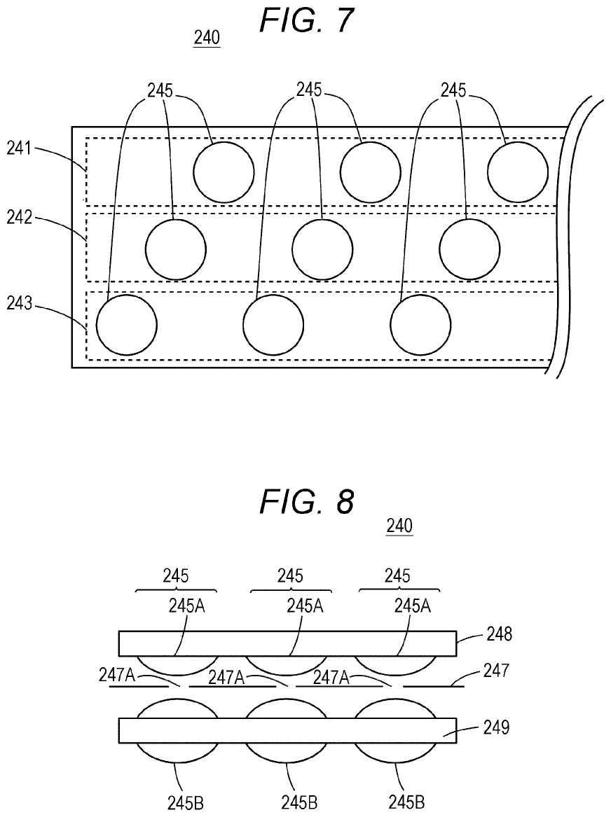

FIG. 7 is a plan view of a microlens array. Referring to FIG. 7, the microlens array 240 includes a plurality of optical elements 245. In each of the plurality of optical elements 245, all the optical surfaces constituting an optical system have a common symmetric surface. Further, the microlens array 240 is installed such that the symmetric surface of each of the plurality of optical elements 245 is parallel to a rotational symmetry axis of the photoreceptor drum 23Y. In the present embodiment, the plurality of optical elements 245 are arranged at positions where positions in the main scanning direction and the sub scanning direction are mutually different, in a state where the optical axes are parallel to each other. The plurality of optical elements 245 individually correspond to the plurality of lens groups 241A, 242A, and 243A respectively included in the first light source substrate 201, the second light source substrate 202, and the third light source substrate 203.

Specifically, the plurality of optical elements 245 belong to any one of a first row group 241, a second row group 242, and a third row group 243. To the first row group 241, the plurality of optical elements 245 individually corresponding to the plurality of first lens groups 241A included in the first light source substrate 201 are classified. To the second row group 242, the plurality of optical elements 245 individually corresponding to the plurality of second lens groups 242A included in the second light source substrate 202 are classified. To the third row group 243, the plurality of optical elements 245 individually corresponding to the plurality of third lens groups 243A included in the third light source substrate 203 are classified.

The plurality of optical elements 245 belonging to the first row group 241 individually correspond to the plurality of first lens groups 241A. The plurality of optical elements 245 belonging to the first row group 241 are arranged such that the optical axis of the optical element 245 passes through the light source 200 at the center of the first lens group 241A corresponding to the optical element 245. The plurality of optical elements 245 individually corresponding to the plurality of second lens groups 242A are arranged such that the optical axis of the optical element 245 passes through the light source 200 at the center of the second lens group 242A corresponding to the optical element 245. The plurality of optical elements 245 individually corresponding to the plurality of third lens groups 243A are arranged such that the optical axis of the optical element 245 passes through the light source 200 at the center of the third lens group 243A corresponding to the optical element 245.

Therefore, the plurality of optical elements 245 belonging to the first row group 241 are arranged along the main scanning direction. The plurality of optical elements 245 belonging to the second row group 242 are arranged along the main scanning direction. The plurality of optical elements 245 belonging to the third row group 243 are arranged along the main scanning direction.

FIG. 8 is a side view showing an internal configuration of the microlens array. Referring to FIG. 8, the microlens array 240 includes a first lens plate 248, a second lens plate 249, and a diaphragm plate 247 disposed between the first lens plate 248 and the second lens plate 249. The first lens plate 248 is formed with a first lens 245A of each of the plurality of optical elements 245. The second lens plate 249 is formed with a second lens 245B of each of the plurality of optical elements 245. The diaphragm plate 247 is formed with a diaphragm 247A corresponding to each of the plurality of optical elements 245. The optical element 245 includes the first lens 245A, the second lens 245B, and the diaphragm 247A.

In one optical element 245, an optical axis of the first lens 245A and an optical axis of the second lens 245B are overlapped. Between the first lens 245A and the second lens 245B, the diaphragm 247A is disposed. The optical element 245 is a telecentric optical system. Further, in the present embodiment, the optical element 245 is an inverted optical system. Therefore, in each of the plurality of optical elements 245, all the optical surfaces constituting the optical system have a common symmetric surface.

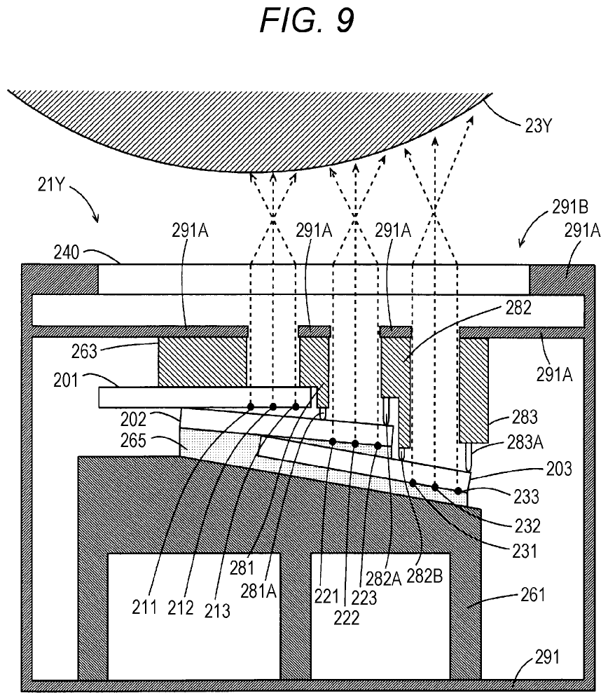

FIG. 9 is an end view showing an internal configuration of an exposure apparatus. FIG. 9 is a view of the exposure apparatus 21Y as seen from a direction perpendicular to the sub scanning direction. Referring to FIG. 9, the light source groups 211, 212, and 213 included in the first light source substrate 201, the light source groups 221, 222, and 223 included in the second light source substrate 202, and the light source groups 231, 232, and 233 included in the third light source substrate 203 are arranged at different positions in the sub scanning direction. Therefore, for an irradiation position where the photoreceptor drum 23Y is irradiated with light emitted from the plurality of light sources 200 at the same timing, corresponding irradiation positions are the same in the sub scanning direction for the plurality of light sources 200 belonging to the same light source group, but corresponding irradiation positions are different in the sub scanning direction for the plurality of light sources 200 belonging to different light source groups.

The microlens array 240, a first heat dissipation member 261, a second heat dissipation member 263, and first to third positioning members 281, 282, and 283 are fixedly disposed in a housing 291 of the exposure apparatus 21Y.

The housing 291 has a rectangular parallelepiped outer shape and is hollow. The housing 291 has an opening 291B formed on an upper surface. The microlens array 240 is fixed to the housing 291 in a state of being inserted into the opening 291B of the housing 291. The housing 291 internally has a holding plate 291A parallel to a bottom surface. The holding plate 291A is fixed to a side wall of the housing 291. The holding plate 291A is formed with a hole through which light emitted from the plurality of light sources 200 passes. Upper surfaces of the second heat dissipation member 263 and the first to third positioning members 281, 282, and 283 each are fixed to a lower surface of the holding plate 291A. Further, a bottom surface of the first heat dissipation member 261 is fixed to an upper surface of a bottom plate of the housing 291. It is sufficient that each of the first heat dissipation member 261 and the second heat dissipation member 263 is made of a material having high thermal conductivity, and the material is not limited.

The first light source substrate 201 is fixed to a bottom surface of the second heat dissipation member 263 in a reference holding area other than the plurality of light emitting areas 251 on an upper surface thereof. For example, an area including the circuit area 253 of the first light source substrate 201 is bonded with an adhesive to the bottom surface of the second heat dissipation member 263. Heat generated by the plurality of light sources 200 formed on the first light source substrate 201 is conducted to the second heat dissipation member 263. The second heat dissipation member 263 is a holding member that holds the first light source substrate 201.

The first positioning member 281 includes first and second parts having different lengths in a vertical direction. The first part has a smaller length in the vertical direction than the second part. The first positioning member 281 has a first adjustment pin 281A projecting downward from the second part. A hole to be inserted with the first adjustment pin 281A is formed in the second part. A thread is formed on an inner surface of the hole, and the hole functions as a female screw. The first adjustment pin 281A is formed with a thread on a surface, and functions as a male screw. The first adjustment pin 281A is engaged with the female screw of the second part, and is rotated with respect to the second part, to change an amount of the projection from the second part.

The second positioning member 282 includes third and fourth parts having different lengths in the vertical direction. The third part has a smaller length in the vertical direction than the fourth part. The second positioning member 282 has a second adjustment pin 282A projecting downward from the third part, and a third adjustment pin 282B projecting downward from the fourth part. A hole to be inserted with the second adjustment pin 282A is formed in the third part. A thread is formed on an inner surface of the hole, and the hole functions as a female screw. The second adjustment pin 282A is formed with a thread on a surface, and functions as a male screw. The second adjustment pin 282A is engaged with the female screw of the third part, and is rotated with respect to the third part, to change an amount of the projection from the third part. A hole to be inserted with the third adjustment pin 282B is formed in the fourth part. A thread is formed on an inner surface of the hole, and the hole functions as a female screw. The third adjustment pin 282B is formed with a thread on a surface, and functions as a male screw. The third adjustment pin 282B is engaged with the female screw of the fourth part, and is rotated with respect to the fourth part, to change an amount of the projection from the fourth part.

The third positioning member 283 has a fourth adjustment pin 283A projecting downward from a bottom surface. The third positioning member 283 is formed, at the bottom surface thereof, with a hole to be inserted with the fourth adjustment pin 283A. A thread is formed on an inner surface of the hole, and the hole functions as a female screw. The fourth adjustment pin 283A is formed with a thread on a surface, and functions as a male screw. The fourth adjustment pin 283A is engaged with the female screw of the third positioning member 283 and is rotated with respect to the third positioning member 283, to change an amount of projection from the third positioning member 283. A tip end of the fourth adjustment pin 283A has a spherical shape.

A plurality of each of the first positioning members 281, the second positioning member 282, and the third positioning member 283 are arranged in the main scanning direction.

In the first light source substrate 201, the reference holding area other than the light emitting area 251 on the upper surface thereof is further fixed to a bottom surface of the first part of the first positioning member 281. Further, for the first light source substrate 201, a position relative to the exposure apparatus 21Y and the photoreceptor drum 23Y is determined such that, among the plurality of light sources 200 belonging to the light source group 213 whose irradiation positions of the plurality of light sources 200 are the most downstream in the sub scanning direction, among the light source groups 211, 212, and 213 included in the first light source substrate 201, a line connecting an irradiation position of light emitted by any representative light source and a rotation center of the photoreceptor drum 23Y is parallel to an optical axis of the optical element 245 corresponding to the first lens group 241A to which the representative light source belongs. Hereinafter, the light source group 213 is referred to as a reference group, and the light source groups 211, 212, 221, 222, 223, 231, 232, and 233 other than the light source group 213 are referred to as sub-groups.

The second light source substrate 202 is fixed to a tip end of the first adjustment pin 281A of the first positioning member 281 and a tip end of the second adjustment pin 282A of the second positioning member 282. The first positioning member 281 and the second positioning member 282 function as a holding member that holds the second light source substrate 202. In the second light source substrate 202, an area other than the light emitting area 251 on an upper surface thereof is individually in contact with the tip end of the first adjustment pin 281A and the tip end of the second adjustment pin 282A, and is bonded with an adhesive. In the second light source substrate 202, the area in contact with the tip end of the first adjustment pin 281A and the tip end of the second adjustment pin 282A is a sub-holding area. The tip end of the first adjustment pin 281A is in contact with the second light source substrate 202 on the circuit area 252 side outside the light emitting area 251 of the second light source substrate 202, and the tip end of the second adjustment pin 282A is in contact with the second light source substrate 202 on the side opposite to the circuit area outside the light emitting area 251 of the second light source substrate 202. Therefore, a position of the second light source substrate 202 can be determined with high accuracy.

At a stage before the second light source substrate 202 is bonded to the first adjustment pin 281A and the second adjustment pin 282A, the position of the second light source substrate 202 is adjusted by the user rotating each of the first adjustment pin 281A and the second adjustment pin 282A. By rotating one or both of the first adjustment pin 281A and the second adjustment pin 282A, the user can adjust an angle formed between a formation surface formed with the plurality of light sources 200 on the first light source substrate 201 and a formation surface formed with the plurality of light sources 200 on the second light source substrate 202. Therefore, the user can set a position of the second light source substrate 202 relative to the first light source substrate 201 such that the angle formed between the formation surface of the first light source substrate 201 and the formation surface of the second light source substrate 202 becomes a desired angle. Specifically, the user sets the position of the second light source substrate 202 such that a position where light emitted from each of the plurality of light sources 200 formed on the second light source substrate 202 converges is to be a surface of the photoreceptor drum 23Y.

The third light source substrate 203 is fixed to a tip end of the third adjustment pin 282B of the second positioning member 282 and the tip end of the fourth adjustment pin 283A of the third positioning member 283. The second positioning member 282 and the third positioning member 283 function as a holding member that holds the third light source substrate 203. In the third light source substrate 203, an area other than the light emitting area 251 on an upper surface thereof is individually in contact with the tip end of the third adjustment pin 282B and the tip end of the fourth adjustment pin 283A, and is bonded with an adhesive. In the third light source substrate 203, the area in contact with the tip end of the third adjustment pin 282B and the tip end of the fourth adjustment pin 283A is a sub-holding area. The tip end of the third adjustment pin 282B is in contact with the third light source substrate 203 on the circuit area 252 side outside the light emitting area 251 of the third light source substrate 203, and the tip end of the fourth adjustment pin 283A is in contact with the third light source substrate 203 on the side opposite to the circuit area 252 outside the light emitting area 251 of the third light source substrate 203. Therefore, a position of the third light source substrate 203 can be determined with high accuracy.

At a stage before the third light source substrate 203 is bonded to the third adjustment pin 282B and the fourth adjustment pin 283A, the position of the third light source substrate 203 is adjusted by the user rotating each of the third adjustment pin 282B and the fourth adjustment pin 283A. By rotating one or both of the third adjustment pin 282B and the fourth adjustment pin 283A, the user can adjust an angle formed between the formation surface formed with the plurality of light sources 200 on the first light source substrate 201 and a formation surface formed with the plurality of light sources 200 on the third light source substrate 203. Therefore, the user can set the position of the third light source substrate 203 relative to the first light source substrate 201 such that the angle formed between the formation surface of the first light source substrate 201 and the formation surface of the third light source substrate 203 becomes a desired angle. Specifically, the user sets the position of the third light source substrate 203 such that a position where light emitted from each of the plurality of light sources 200 formed on the third light source substrate 203 converges is to be the surface of the photoreceptor drum 23Y.

The reference holding area of the first light source substrate 201 has a larger area than either of the sub-holding area of the second light source substrate 202 and the sub-holding area of the third light source substrate 203. This causes heat generated by the plurality of light sources 200 formed on the first light source substrate 201 to be conducted to the second heat dissipation member 263, enabling efficient dissipation of the heat generated in the first light source substrate 201.

The tip end of each of the first adjustment pin 281A, the second adjustment pin 282A, the third adjustment pin 282B, and the fourth adjustment pin 283A has a spherical shape. Therefore, the first adjustment pin 281A and the second adjustment pin 282A are in point contact with the second light source substrate 202, facilitating a positioning operation of the second light source substrate 202. Similarly, the third adjustment pin 282B and the fourth adjustment pin 283A are in point contact with the third light source substrate 203, facilitating a positioning operation of the third light source substrate 203.

Further, the second heat dissipation member 263 holds the first light source substrate 201 at the upper surface, the first adjustment pin 281A and the second adjustment pin 282A hold the second light source substrate 202 at the upper surface, and the third adjustment pin 282B and the fourth adjustment pin 283A hold the third light source substrate 203 at the upper surface. Since back surfaces of the first light source substrate 201, the second light source substrate 202, and the third light source substrate 203 are formed with a sealing glass layer covering the plurality of light sources 200, the back surfaces are unable to be used as a reference for positioning. Therefore, the first light source substrate 201, the second light source substrate 202, and the third light source substrate 203 are held at the upper surfaces thereof, enabling accurate positioning.

Between the first heat dissipation member 261 and each of the second light source substrate 202 and the third light source substrate 203, an intermediate member 265 is disposed. The intermediate member 265 is made of a material having a high thermal conductivity. The intermediate member 265 desirably has fluidity or elasticity at the time of manufacture. The intermediate member 265 is a resin or grease. The resin is desirably thermosetting or ultraviolet-curable. Therefore, heat generated by the plurality of light sources 200 formed on the second light source substrate 202 and the third light source substrate 203 is conducted to the first heat dissipation member 261 through the intermediate member 265.

Whereas, since the first light source substrate 201 is in contact with the second heat dissipation member 263, heat generated in the first light source substrate 201 is conducted to the second heat dissipation member 263 and is dissipated by the second heat dissipation member 263. The first light source substrate 201 is not in contact with the first heat dissipation member 261. Therefore, the first light source substrate 201 does not conduct heat from the first heat dissipation member 261. Between the first light source substrate 201 and the first heat dissipation member 261, a heat insulating material may be disposed. Since the first light source substrate 201 does not conduct heat from the first heat dissipation member 261, the first light source substrate 201 is not affected by heat generated by the second light source substrate 202 and the third light source substrate 203.

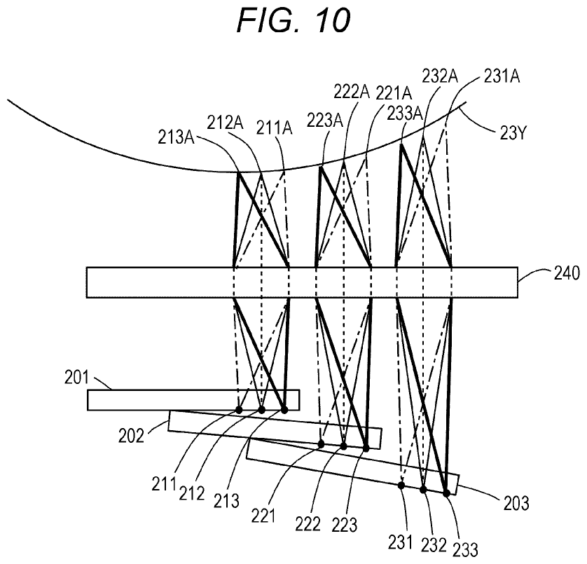

FIG. 10 is a first view schematically showing a relationship between positions of the plurality of light sources and irradiation positions on the photoreceptor drum. The view here shows a relationship between a plurality of light sources and an irradiation position in a state where the first light source substrate 201, the second light source substrate 202, and the third light source substrate 203 are positioned at ideal positions. Referring to FIG. 10, among the plurality of light sources 200 formed on the first light source substrate 201, light emitted from the plurality of light sources 200 belonging to the light source group 211 converges at an irradiation position 211A on the photoreceptor drum 23Y, light emitted from the plurality of light sources 200 belonging to the light source group 212 converges at an irradiation position 212A on the photoreceptor drum 23Y, and light emitted from the plurality of light sources 200 belonging to the light source group 213 converges at an irradiation position 213A on the photoreceptor drum 23Y.

Among the plurality of light sources 200 formed on the second light source substrate 202, light emitted from the plurality of light sources 200 belonging to the light source group 221 converges at an irradiation position 221A on the photoreceptor drum 23Y, light emitted from the plurality of light sources 200 belonging to the light source group 222 converges at an irradiation position 222A on the photoreceptor drum 23Y, and light emitted from the plurality of light sources 200 belonging to the light source group 223 converges at an irradiation position 223A on the photoreceptor drum 23Y.

Among the plurality of light sources 200 formed on the third light source substrate 203, light emitted from the plurality of light sources 200 belonging to the light source group 231 converges at an irradiation position 231A on the photoreceptor drum 23Y, light emitted from the plurality of light sources 200 belonging to the light source group 232 converges at an irradiation position 232A on the photoreceptor drum 23Y, and light emitted from the plurality of light sources 200 belonging to the light source group 233 converges at an irradiation position 233A on the photoreceptor drum 23Y.

The plurality of optical elements 245 included in the microlens array 240 are inverted optical systems. When a distance between the light source 200 and the optical element 245 is a, a distance between the optical element 245 and a focal point is b, and a focal distance of the optical element 245 is f, the following equation (1) is satisfied.

l/a+l/b=l/f (1)

The second light source substrate 202 is positioned at a position where the formation surface thereof crosses the formation surface of the first light source substrate 201. The second light source substrate 202 includes the light source groups 221, 222, and 223. The light source group 221 is arranged at a position closest to the circuit area 252 in the sub scanning direction, and the light source group 223 is arranged at a position farthest from the circuit area 252 in the sub scanning direction. Therefore, a first distance between any one of the plurality of light sources 200 belonging to the light source group 221 and the optical element 245 corresponding to the second lens group 242A to which the light source 200 belongs is shorter than a second distance between any one of the plurality of light sources 200 belonging to the light source group 223 and the optical element 245 corresponding to the second lens group 242A to which the light source 200 belongs. Therefore, since the surface of the photoreceptor drum 23Y is a curved surface, the irradiation positions 221A, 222A, and 223A where light emitted respectively from the plurality of light sources 200 belonging to the light source group 221, the plurality of light sources 200 belonging to the light source group 222, and the plurality of light sources 200 belonging to the light source group 223 converges is to be the surface of the photoreceptor drum 23Y.

The third light source substrate 203 is positioned at a position where the formation surface thereof crosses the formation surface of the first light source substrate 201. The third light source substrate 203 includes the light source groups 231, 232, and 233. The light source group 231 is arranged on the most downstream in the sub scanning direction, and the light source group 233 is arranged on the most upstream in the sub scanning direction. Therefore, a first distance between any one of the plurality of light sources 200 belonging to the light source group 231 and the optical element 245 corresponding to the third lens group 243A to which the light source 200 belongs is shorter than a second distance between any one of the plurality of light sources 200 belonging to the light source group 233 and the optical element 245 corresponding to the third lens group 243A to which the light source 200 belongs. Therefore, since the surface of the photoreceptor drum 23Y is a curved surface, the irradiation positions 231A, 232A, and 233A where light emitted respectively from the plurality of light sources 200 belonging to the light source group 231, the plurality of light sources 200 belonging to the light source group 232, and the plurality of light sources 200 belonging to the light source group 233 converges is to be the surface of the photoreceptor drum 23Y.

As described above, since light emitted from each of the plurality of light sources 200 converges on the surface of the photoreceptor drum 23Y, image quality of an electrostatic latent image formed on the photoreceptor drum 23Y can be improved.

Moreover, an angle of the formation surface of the first light source substrate 201 may be adjusted. The first light source substrate 201 includes the light source groups 211, 212, and 213. The light source group 211 is arranged at a position closest to the circuit area 252 in the sub scanning direction, and the light source group 213 is arranged at a position farthest from the circuit area 252 in the sub scanning direction. Therefore, a first distance between any one of the plurality of light sources 200 belonging to the light source group 211 and the optical element 245 corresponding to the first lens group 241A to which the light source 200 belongs may simply be made shorter than a second distance between any one of the plurality of light sources 200 belonging to the light source group 213 and the optical element 245 corresponding to the first lens group 241A to which the light source 200 belongs. Specifically, an adjustment pin extending downward of the first part of the first positioning member 281 may be provided, and the first distance and the second distance of the first light source substrate 201 may be determined by the adjustment pin.

The CPU 111 functions as a light source control part that controls the exposure apparatus 21Y and causes the light sources 200 to emit light. When the plurality of light sources 200 belonging to each of the light source groups 211, 212, 213, 221, 222, 223, 231, 232, and 233 emit light at the same timing, the irradiation positions 211A, 212A, 213A, 221A, 222A, 223A, 231A, 232A, and 233A are different positions in the sub scanning direction in the photoreceptor drum 23Y. Therefore, in order to align the irradiation positions 211A, 212A, 213A, 221A, 222A, 223A, 231A, 232A, and 233A in the sub scanning direction on the photoreceptor drum 23Y, the CPU 111 controls the light emission timing for light emission of the plurality of light sources 200 to be different for each of the light source groups 211, 212, 213, 221, 222, 223, 231, 232, and 233.

Among the plurality of light sources 200 formed on the first light source substrate 201, the CPU 111 uses the light source 200 belonging to the light source group 213, which is a reference group, as a reference for determining the light emission timing of the plurality of light sources 200 included in the exposure apparatus 21Y, to determine the light emission timing of the plurality of light sources 200 individually belonging to other light source groups 212, 213, 221, 222, 223, 231, 232, and 233. The first light source substrate 201 is a reference substrate including the light source group 213, which is the reference group.

As described above, the first light source substrate 201 is not in contact with the first heat dissipation member 261. Therefore, the first light source substrate 201 is not affected by heat generated by the second light source substrate 202 and the third light source substrate 203. Whereas, the first light source substrate 201 is in contact with the second heat dissipation member 263, and the second heat dissipation member 263 dissipates heat generated by the first light source substrate 201. Therefore, even when a temperature of the second light source substrate 202 and the third light source substrate 203 varies, the first light source substrate 201 can be made not to be affected by the heat generated by the second light source substrate 202 and the third light source substrate 203. Since the CPU 111 uses the light source group 213 of the first light source substrate 201 as a reference for determining the light emission timing of the plurality of light sources 200 individually belonging to the other light source groups 211, 212, 221, 222, 223, 231, 232, and 233, the light emission timing of the plurality of light sources 200 can be accurately adjusted.

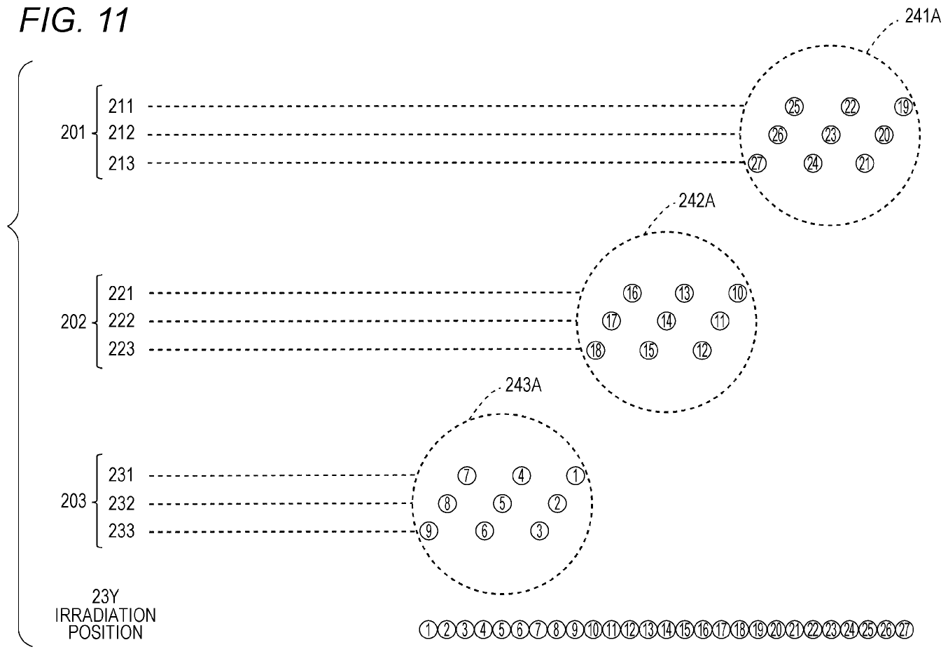

FIG. 11 is a second view schematically showing a relationship between positions of the plurality of light sources and irradiation positions on the photoreceptor drum. The view here shows an ideal irradiation position in a case where the light emission timing for the plurality of light sources 200 to emit light is adjusted such that positions irradiated with light on the photoreceptor drum 23Y are the same position in the sub scanning direction. Numerals shown on each of the first light source substrate 201, the second light source substrate 202, and the third light source substrate 203 indicate positions of the plurality of light sources 200 and numbers assigned to the light sources. Numerals shown on the photoreceptor drum 23Y indicate irradiation positions and numbers assigned to the light sources 200 corresponding to the irradiation positions.

The photoreceptor drum 23Y moves relative to the exposure apparatus 21Y in the sub scanning direction at a predetermined velocity. Therefore, the CPU 111 controls the exposure apparatus 21Y to shift the light emission timing of the plurality of light sources 200 for each light source group. As a result, the irradiation positions 211A, 212A, 213A, 221A, 222A, 223A, 231A, 232A, and 233A can be aligned in the sub scanning direction.

In the third light source substrate 203, three light sources 200 assigned with numbers 7, 4 and 1 belonging to the light source group 231 in the third row, three light sources 200 assigned with numbers 8, 5 and 2 belonging to the light source group 232 in the second row, and three light sources 200 assigned with numbers 9, 6 and 3 belonging to the light source group 233 in the first row belong to the third lens group 243A. The CPU 111 simultaneously causes light emission from the plurality of light sources 200 belonging to the light source group 231 in the third row, simultaneously causes light emission from the plurality of light sources 200 belonging to the light source group 232 in the second row after a predetermined time has elapsed, and simultaneously causes light emission from the plurality of light sources 200 belonging to the light source group 233 in the first row after a predetermined time has further elapsed. This allows the CPU 111 to align the irradiation positions 231A, 232A, and 233A on the photoreceptor drum 23Y individually corresponding to the first to ninth light sources 200 with the photoreceptor drum 23Y in the sub scanning direction.

In the second light source substrate 202, three light sources 200 assigned with numbers 16, 13 and 10 belonging to the light source group 221 in the sixth row, three light sources 200 assigned with numbers 17, 14 and 11 belonging to the light source group 222 in the fifth row, and three light sources 200 assigned with numbers 18, 15 and 12 belonging to the light source group 223 in the fourth row belong to the second lens group 242A. The CPU 111 simultaneously causes light emission from the plurality of light sources 200 belonging to the light source group 221 in the sixth row, simultaneously causes light emission from the plurality of light sources 200 belonging to the light source group 222 in the fifth row after a predetermined time has elapsed, and simultaneously causes light emission from the plurality of light sources 200 belonging to the light source group 223 in the fourth row after a predetermined time has further elapsed. This allows the CPU 111 to align the irradiation positions 221A, 222A, and 223A on the photoreceptor drum 23Y corresponding to the 10th to 18th light sources 200 with the photoreceptor drum 23Y in the sub scanning direction.

In the first light source substrate 201, three light sources 200 assigned with numbers 25, 22 and 19 belonging to the light source group 211 in the ninth row, three light sources 200 assigned with numbers 26, 23 and 20 belonging to the light source group 212 in the eighth row, and three light sources 200 assigned with numbers 27, 24 and 21 belonging to the light source group 213 in the seventh row belong to the first lens group 241A. The CPU 111 simultaneously causes light emission from the plurality of light sources 200 belonging to the light source group 211 in the ninth row, simultaneously causes light emission from the plurality of light sources 200 belonging to the light source group 212 in the eighth row after a predetermined time has elapsed, and simultaneously causes light emission from the plurality of light sources 200 belonging to the light source group 213 in the seventh row after a predetermined time has further elapsed. This allows the CPU 111 to align the irradiation positions 211A, 212A, and 213A on the photoreceptor drum 23Y corresponding to the 19th to 27th light sources 200 with the photoreceptor drum 23Y in the sub scanning direction.

Further, since the MFP 100 includes the exposure apparatuses 21Y, 21M, 21C, and 21K, image quality of an image formed on a recording medium such as a sheet is improved.

<Modification>

An MFP 100 in a modification has a microlens array 240A of an erecting optical system instead of the microlens array 240 of the inverted optical system.

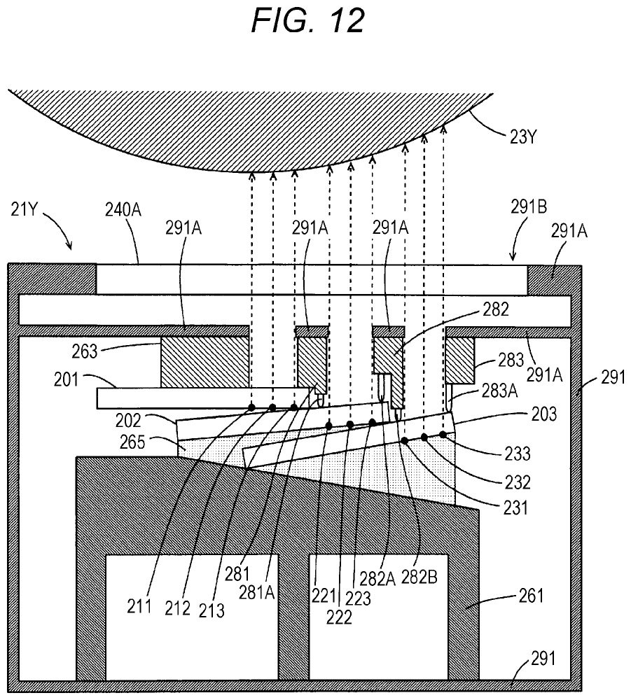

FIG. 12 is an end view showing an internal configuration of an exposure apparatus according to the modification. FIG. 12 is a view of an exposure apparatus 21Y according to the modification as seen from a direction perpendicular to the sub scanning direction. Referring to FIG. 12, a point different from the exposure apparatus 21Y shown in FIG. 9 is that the microlens array 240 is changed to the microlens array 240A. The plurality of optical elements 245 included in the microlens array 240A are erecting optical systems.

For a first light source substrate 201, a position relative to the exposure apparatus 21Y and a photoreceptor drum 23Y is determined such that, among light source groups 211, 212, and 213 included in the first light source substrate 201, a distance between the photoreceptor drum 23Y and a plurality of light sources 200 belonging to a light source group 211 whose irradiation positions of the plurality of light sources 200 are the most downstream in the sub scanning direction is the shortest. In this case, among the plurality of light sources 200 belonging to the light source group 211, a line connecting an irradiation position of light emitted by any representative light source and a rotation center of the photoreceptor drum 23Y is parallel to an optical axis of an optical element 245 corresponding to a first lens group 241A to which the representative light source belongs. In the modification, the light source group 211 is a reference group, and light source groups 212, 213, 221, 222, 223, 231, 232, and 233 other than the light source group 211 are sub-groups.

A user can set a position of a second light source substrate 202 relative to the first light source substrate 201 such that an angle formed between a formation surface of the first light source substrate 201 and a formation surface of the second light source substrate 202 becomes a desired angle. Specifically, the user sets the position of the second light source substrate 202 such that a position where light emitted from each of the plurality of light sources 200 formed on the second light source substrate 202 converges is to be a surface of the photoreceptor drum 23Y.

The user can set a position of a third light source substrate 203 relative to the first light source substrate 201 such that an angle formed between the formation surface of the first light source substrate 201 and a formation surface of the third light source substrate 203 becomes a desired angle. Specifically, the user sets the position of the third light source substrate 203 such that a position where light emitted from each of the plurality of light sources 200 formed on the third light source substrate 203 converges is to be the surface of the photoreceptor drum 23Y.

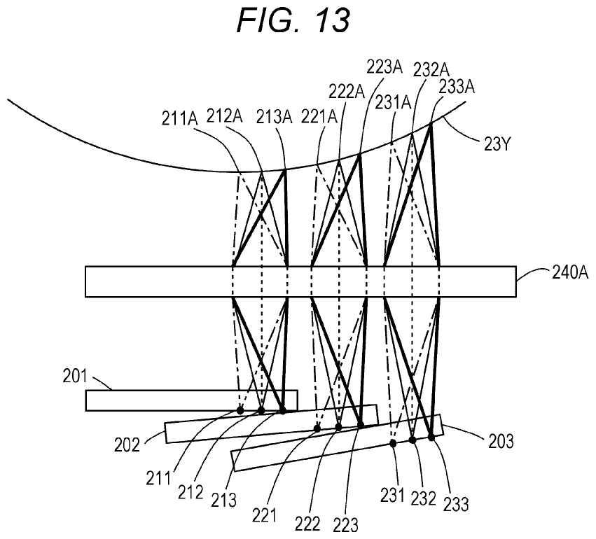

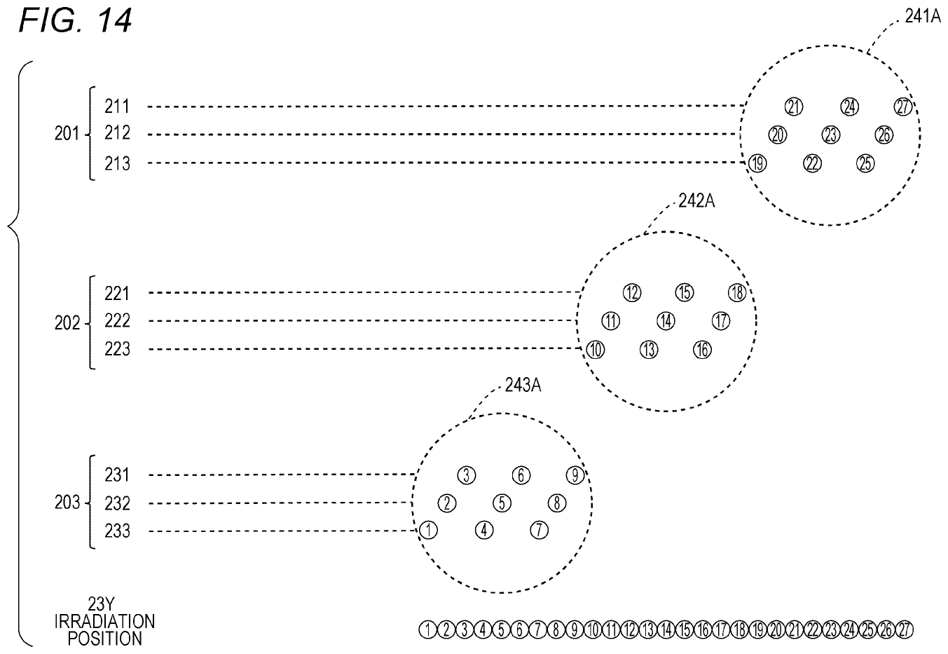

FIG. 13 is a first view schematically showing a relationship between positions of a plurality of light sources and irradiation positions on the photoreceptor drum according to the modification. The view here shows a relationship between a plurality of light sources and an irradiation position in a state where the first light source substrate 201, the second light source substrate 202, and the third light source substrate 203 in the modification are positioned at ideal positions. The plurality of optical elements 245 included in the microlens array 240A are erecting optical systems.

The second light source substrate 202 is positioned at a position where the formation surface thereof crosses the formation surface of the first light source substrate 201. The second light source substrate 202 includes the light source groups 221, 222, and 223. The light source group 221 is arranged at a position closest to the circuit area 252 in the sub scanning direction, and the light source group 223 is arranged at a position farthest from the circuit area 252 in the sub scanning direction. Therefore, a first distance between any one of the plurality of light sources 200 belonging to the light source group 221 and the optical element 245 corresponding to a second lens group 242A to which the light source 200 belongs is longer than a second distance between any one of the plurality of light sources 200 belonging to the light source group 223 and the optical element 245 corresponding to the second lens group 242A to which the light source 200 belongs. Therefore, since the surface of the photoreceptor drum 23Y is a curved surface, the irradiation positions 221A, 222A, and 223A where light emitted respectively from the plurality of light sources 200 belonging to the light source group 221, the plurality of light sources 200 belonging to the light source group 222, and the plurality of light sources 200 belonging to the light source group 223 converges is to be the surface of the photoreceptor drum 23Y.

The third light source substrate 203 is positioned at a position where the formation surface thereof crosses the formation surface of the first light source substrate 201. The third light source substrate 203 includes the light source groups 231, 232, and 233. The light source group 231 is arranged at a position closest to the circuit area 252 in the sub scanning direction, and the light source group 233 is arranged at a position farthest from the circuit area 252 in the sub scanning direction. Therefore, a first distance between any one of the plurality of light sources 200 belonging to the light source group 231 and the optical element 245 corresponding to a third lens group 243A to which the light source 200 belongs is longer than a second distance between any one of the plurality of light sources 200 belonging to the light source group 233 and the optical element 245 corresponding to the third lens group 243A to which the light source 200 belongs. Therefore, since the surface of the photoreceptor drum 23Y is a curved surface, the irradiation positions 231A, 232A, and 233A where light emitted respectively from the plurality of light sources 200 belonging to the light source group 231, the plurality of light sources 200 belonging to the light source group 232, and the plurality of light sources 200 belonging to the light source group 233 converges is to be the surface of the photoreceptor drum 23Y.

As described above, since light emitted from each of the plurality of light sources 200 converges on the surface of the photoreceptor drum 23Y, image quality of an electrostatic latent image formed on the photoreceptor drum 23Y can be improved.

Moreover, an angle of the formation surface of the first light source substrate 201 may be adjusted. The first light source substrate 201 includes the light source groups 211, 212, and 213. The light source group 211 is arranged on the most downstream in the sub scanning direction, and the light source group 213 is arranged on the most upstream in the sub scanning direction. Therefore, a first distance between any one of the plurality of light sources 200 belonging to the light source group 211 and the optical element 245 corresponding to the first lens group 241A to which the light source 200 belongs may simply be made longer than a second distance between any one of the plurality of light sources 200 belonging to the light source group 213 and the optical element 245 corresponding to the first lens group 241A to which the light source 200 belongs.

FIG. 14 is a second view schematically showing a relationship between positions of a plurality of light sources and irradiation positions on the photoreceptor drum according to the modification. The view here shows an ideal irradiation position in a case where the light emission timing for the plurality of light sources 200 to emit light is adjusted such that positions irradiated with light on the photoreceptor drum 23Y are the same position in the sub scanning direction. Numerals shown on each of the first light source substrate 201, the second light source substrate 202, and the third light source substrate 203 indicate positions of the plurality of light sources 200 and numbers assigned to the light sources. Numerals shown on the photoreceptor drum 23Y indicate irradiation positions and numbers assigned to the light sources 200 corresponding to the irradiation positions.

The photoreceptor drum 23Y moves relative to the exposure apparatus 21Y in the sub scanning direction at a predetermined velocity. Therefore, the CPU 111 in the modification controls the exposure apparatus 21Y to shift the light emission timing of the plurality of light sources 200 for each light source group. As a result, the irradiation positions 211A, 212A, 213A, 221A, 222A, 223A, 231A, 232A, and 233A can be aligned in the sub scanning direction.

In the third light source substrate 203, three light sources 200 assigned with numbers 1, 4 and 7 belonging to the light source group 233 in the first row, three light sources 200 assigned with numbers 2, 5 and 8 belonging to the light source group 232 in the second row, and three light sources 200 assigned with numbers 3, 6 and 9 belonging to the light source group 231 in the third row belong to the third lens group 243A. The CPU 111 in the modification simultaneously causes light emission from the plurality of light sources 200 belonging to the light source group 233 in the first row, simultaneously causes light emission from the plurality of light sources 200 belonging to the light source group 232 in the second row after a predetermined time has elapsed, and simultaneously causes light emission from the plurality of light sources 200 belonging to the light source group 231 in the third row after a predetermined time has further elapsed. This allows the CPU 111 in the modification to align the irradiation positions 231A, 232A, and 233A on the photoreceptor drum 23Y individually corresponding to the first to ninth light sources 200 with the photoreceptor drum 23Y in the sub scanning direction.

In the second light source substrate 202, three light sources 200 assigned with numbers 10, 13 and 16 belonging to the light source group 223 in the fourth row, three light sources 200 assigned with numbers 11, 14 and 17 belonging to the light source group 222 in the fifth row, and three light sources 200 assigned with numbers 12, 15 and 18 belonging to the light source group 221 in the sixth row belong to the second lens group 242A. The CPU 111 in the modification simultaneously causes light emission from the plurality of light sources 200 belonging to the light source group 223 in the fourth row, simultaneously causes light emission from the plurality of light sources 200 belonging to the light source group 222 in the fifth row after a predetermined time has elapsed, and simultaneously causes light emission from the plurality of light sources 200 belonging to the light source group 221 in the sixth row after a predetermined time has further elapsed. This allows the CPU 111 in the modification to align the irradiation positions 221A, 222A, and 223A on the photoreceptor drum 23Y corresponding to the 10th to 18th light sources 200 with the photoreceptor drum 23Y in the sub scanning direction.

In the first light source substrate 201, three light sources 200 assigned with numbers 19, 22 and 25 belonging to the light source group 213 in the seventh row, three light sources 200 assigned with numbers 20, 23 and 26 belonging to the light source group 212 in the eighth row, and three light sources 200 assigned with numbers 21, 24 and 27 belonging to the light source group 211 in the ninth row belong to the first lens group 241A. The CPU 111 simultaneously causes light emission from the plurality of light sources 200 belonging to the light source group 213 in the seventh row, simultaneously causes light emission from the plurality of light sources 200 belonging to the light source group 212 in the eighth row after a predetermined time has elapsed, and simultaneously causes light emission from the plurality of light sources 200 belonging to the light source group 211 in the ninth row after a predetermined time has further elapsed. This allows the CPU 111 to align the irradiation positions 211A, 212A, and 213A on the photoreceptor drum 23Y corresponding to the 19th to 27th light sources 200 with the photoreceptor drum 23Y in the sub scanning direction.

In the exposure apparatus 21Y in the modification, the second light source substrate 202 is arranged such that a first distance between any one of the plurality of light sources 200 belonging to the light source group 221 and the optical element 245 corresponding to the second lens group 242A to which the light source 200 belongs is longer than a second distance between any one of the plurality of light sources 200 belonging to the light source group 223 and the optical element 245 corresponding to the second lens group 242A to which the light source 200 belongs. Further, the third light source substrate 203 is arranged such that a first distance between any one of the plurality of light sources 200 belonging to the light source group 231 and the optical element 245 corresponding to the third lens group 243A to which the light source 200 belongs is longer than a second distance between any one of the plurality of light sources 200 belonging to the light source group 233 and the optical element 245 corresponding to the third lens group 243A to which the light source 200 belongs. Therefore, a height in an overlapping direction of the first light source substrate 201, the second light source substrate 202, and the third light source substrate 203 can be shortened. Accordingly, a height of the exposure apparatus 21Y can be shortened.

<Supplementary Note>

(1) The exposure apparatus according to claim 7, in which

one or more of the sub-substrates and the heat dissipation member are arranged at positions in contact with each other directly or through a heat conduction member, and

the reference substrate and the heat dissipation member are arranged at positions not in contact with each other.

(2) The exposure apparatus according to (1), further including a heat insulating member disposed between the reference substrate and the heat dissipation member.

(3) The exposure apparatus according to claim 8, in which the holder has a thermal conductivity equal to or higher than a predetermined value.

Although embodiments of the present invention have been described and illustrated in detail, the disclosed embodiments are made for purposes of illustration and example only and not limitation. The scope of the present invention should be interpreted not by terms of the description above but by terms of the appended claims, and it is intended to include all modifications within the meaning and scope equivalent to the claims

What is claimed is:

1. An exposure apparatus comprising:
a plurality of light source substrates on which a plurality of light sources aligned in a first direction are aligned in a plurality of rows and formed on a formation surface;
an optical element that causes light emitted from the light sources to form an image on a surface of an image carrier that has a cylindrical shape and rotates with a rotational symmetry axis parallel to the first direction;
a microlens array in which a plurality of the optical elements aligned in the first direction are aligned in a plurality of rows; and
a holder that holds a plurality of the light source substrates, wherein
in each of a plurality of the light source substrates, at least two of the light sources are formed at different positions in a second direction intersecting with the first direction and being parallel to the formation surface, and
the holder holds a plurality of the light source substrates to cause the formation surfaces of a plurality of the light source substrates to cross each other.

2. The exposure apparatus according to claim 1, wherein, in each of a plurality of the optical elements formed in the microlens array, all optical surfaces constituting an optical system have a common symmetric surface, and the common symmetric surface is parallel to the rotational symmetry axis of the image carrier.

3. The exposure apparatus according to claim 1, wherein
each of a plurality of the optical elements causes light emitted from at least two of the light sources formed at different positions in the second direction to form an image on the image carrier, and
the holder holds at least one of a plurality of the light source substrates to cause distances between the optical element and each of at least two of the light sources formed at different positions in the second direction to be different.

4. The exposure apparatus according to claim 3, wherein the holder includes an adjuster that adjusts a distance between the optical element and each of at least two of the light sources at different positions in the second direction, in at least one of a plurality of the light source substrates.

5. The exposure apparatus according to claim 3, wherein
each of a plurality of the light source substrates has a light emitting area formed with a plurality of the light sources, and a circuit area formed with a driving circuit that drives a plurality of the light sources,
the circuit area is overlapped with another of the light source substrates in an optical axis direction, and
the holder holds each of at least one of the light source substrates with inclination to another of the light source substrates, to cause an optical axial distance between a first light source and the optical element to be longer than an optical axial distance between a second light source and the optical element, in the first light source and the second light source in which a distance from the circuit area is longer than that of the first light source, among at least two of the light sources formed at different positions in the second direction on the light source substrate.

6. The exposure apparatus according to claim 1, wherein
a plurality of the light source substrates include a reference substrate and one or more sub-substrates other than the reference substrate,
the exposure apparatus further comprises a heat dissipation member that dissipates heat generated by each of one or more of the sub-substrates, and
the heat dissipation member and the reference substrate are individually arranged at positions not in contact with each other.

7. The exposure apparatus according to claim 6, wherein
each of a plurality of the light source substrates has a light emitting area formed with a plurality of the light sources, and a circuit area formed with a driving circuit that drives a plurality of the light sources,
the holder holds each of a plurality of the light source substrates at a position outside the light emitting area, and
a reference holding area in which the holder holds the reference substrate has a larger area than a sub-holding area in which the holder holds the sub-substrate.

8. The exposure apparatus according to claim 6, further comprising:
a light emission controller that determines light emission timing of a plurality of the light sources formed on each of one or more of the sub-substrates by using, as a reference, at least one of a plurality of the light sources formed on the reference substrate.

9. An image forming apparatus comprising the exposure apparatus according to claim 1.
